(19) United States
(12) Patent Application Publication
(10) Pub. No.: US 2020/0186878 A1
(43) Pub. Date: Jun. 11, 2020

(54) Efficient Prefetching of Common Video Clips

(71) Applicant: TENSERA NETWORKS LTD., Hod Hasharon (IL)

(72) Inventors: Eilon Regev, Givatayim (IL); Daniel Yellin, Raanana (IL); Shimon Moshavi, Beit Shemesh (IL); David Ben Eli, Modiin (IL)

(21) Appl. No.: 16/468,682

(22) PCT Filed: Jan. 11, 2018
(86) PCT No.: PCT/IB2018/050173

§ 371 Date: Jun. 12, 2019

Related U.S. Application Data
(60) Provisional application No. 62/449,145, filed on Jan. 23, 2017.
(60) Provisional application No. 62/512,020, filed on May 28, 2017.
(60) Provisional application No. 62/513,509, filed on Jun. 1, 2017.

(51) Int. Cl. H04N 21/454; H04N 21/433; H04N 21/414; H04N 21/462; H04L 29/08

(52) U.S. Cl. CPC H04N 21/454; H04N 21/4331; H04L 67/2847; H04N 21/4622; H04N 21/41407

(57) ABSTRACT

An apparatus includes a network interface (64) for communicating over a communication network (32), and one or more processors (44, 68). In some embodiments, the processors are configured to identify that multiple different video content items, which are available for consumption over the communication network, contain a common interval having the same content, and to prefetch a single instance of the identified common interval to a cache memory (52) of a user device (24), for display with any of the multiple video content items. In other embodiments, the processors are configured to identify that a video content item, which is available for consumption over the communication network, is restricted from prefetching due to Digital Rights Management protection, but that an initial portion of the video content item is not required to be restricted from prefetching, and to prefetch the initial portion to a cache memory of a user device.

### CROSS-REFERENCE TO RELATED APPLICATIONS

This application claims the benefit of U.S. Provisional Patent Application 62/449,145, filed Jan. 23, 2017, U.S. Provisional Patent Application 62/512,020, filed May 28, 2017, and U.S. Provisional Patent Application 62/513,509, filed Jun. 1, 2017, whose disclosures are incorporated herein by reference.

### FIELD OF THE INVENTION

The present invention relates generally to prefetching of content to user devices, and particularly to methods and systems for prefetching Common Video Clips (CVC).

### BACKGROUND OF THE INVENTION

Various techniques are known in the art for prefetching content to user devices. For example, U.S. Patent Application Publication 2016/0021211, whose disclosure is incorporated herein by reference, describes a method for content delivery that includes defining a guaranteed prefetching mode, in which content is continuously prefetched from a content source to a communication terminal of a user so as to maintain the communication terminal synchronized with the content source. One or more time-of-day intervals, during which the user is expected to access given content, are identified. During the identified time-of-day intervals, the given content is prefetched from the content source to the communication terminal using the guaranteed prefetching mode.

Some prefetching schemes focus on prefetching video content that adheres to a certain video format. For example, PCT International Publication WO 2016/063161, whose disclosure is incorporated herein by reference, describes a method that includes prefetching to a memory of a user device one or more content segments of a content item. The content item includes multiple content segments and an index that specifies storage locations of the content segments. In an embodiment, the content item comprises a HTTP Live Streaming (HLS) item, and the index comprises a playlist of the HLS item. The index is modified to indicate that the prefetched content segments are to be retrieved from the memory of the user device. At least part of the content item is delivered by retrieving at least some of the content segments in accordance with the modified index.

### SUMMARY OF THE INVENTION

An embodiment of the present invention that is described herein provides an apparatus including a network interface for communicating over a communication network, and one or more processors. In some embodiments, the one or more processors are configured to identify that multiple different video content items, which are available for consumption over the communication network, contain a common interval having the same content, and to prefetch a single instance of the identified common interval to a cache memory of a user device, for display with any of the multiple video content items.

In some embodiments, the one or more processors are configured to display the prefetched single instance of the common interval with a video content item that is prefetched, or with a video content item that is fetched and displayed in real-time. In some embodiments, the one or more processors are configured to receive a notification that specifies the common interval, from a system external to the apparatus. In an example embodiment, the notification specifies respective locations of the common interval in two or more of the video content items.

In an embodiment, the one or more processors are configured to identify the common interval by comparing portions of two or more of the video content items. In another embodiment, the one or more processors are configured to prefetch the single instance of the common interval, only if the common interval appears in more than a predefined number of video content items. In yet another embodiment, the one or more processors are configured to prefetch the single instance of the common interval, only if the common interval is longer than a predefined length.

In a disclosed embodiment, the one or more processors are configured to store the single instance of the common interval in the cache memory of the user device separately from any of the multiple video content items. In an embodiment, the one or more processors are configured to prefetch the single instance of the common interval as part of prefetching or fetching a segment of one of the multiple video content items. In an alternative embodiment, the one or more processors are configured to prefetch the single instance of the common interval independently of prefetching or fetching any segment of the multiple video content items.

In some embodiments, the one or more processors are configured to determine that the single instance of the common interval is already cached in the cache memory of the user device, and in response to fetch or prefetch only a partial segment of one of the multiple video content items that excludes the common interval. In some embodiments, the one or more processors are configured to display a segment of one of the multiple video content items that includes the common interval, by (i) fetching or prefetching a partial segment that excludes the common interval and (ii) assembling the segment by combining the partial segment with the cached single instance of the common interval.

In an embodiment, the one or more processors are configured to search for the common interval only within a predefined partial subset of segments positions in the video content items. In another embodiment, multiple copies of the video content items are available at multiple respective encoding rates, and the one or more processors are configured to identify the common interval and prefetch the single instance in only a predefined partial subset of the multiple encoding rates.

In yet another embodiment, the one or more processors are configured to prefetch only a portion of the single instance of the common interval, which is sufficient for starting immediate playback in the user device. In still another embodiment, the one or more processors are configured to prefetch the single instance even though the video content items are subject to Digital Rights Management (DRM) protection. In an example embodiment, the one or more processors are configured to convert the single instance into a non-DRM format.

There is additionally provided, in accordance with an embodiment of the present invention, an apparatus including a network interface for communicating over a communication network, and one or more processors. The processors are configured to identify that a video content item, which is available for consumption over the communication network, is restricted from prefetching due to Digital Rights Management protection, but that an initial portion of the video content item is not required to be restricted from prefetching, and to prefetch the initial portion to a cache memory of a user device.

In some embodiments, the one or more processors are configured to convert the initial portion into a format that enables prefetching of the initial portion, and to prefetch the converted initial portion to the cache memory of the user device. In an embodiment, the one or more processors are configured to receive, from a content provider, information that enables conversion into the format that enables the prefetching, and to convert the initial portion using the information.

In another embodiment, the one or more processors are configured to receive a version of the initial portion in a format that enables prefetching of the initial portion, and to prefetch the received version of the initial portion to the cache memory of the user device. In yet another embodiment, the one or more processors are configured to store the initial portion in the cache memory of the user device in a format that restricts prefetching in accordance with the DRM protection, and, upon retrieving the initial portion from the cache memory in order to present the initial portion, to convert the initial portion into a format that does not restrict the prefetching, or to unlock an access restriction of the initial portion.

In an embodiment, the one or more processors are configured to identify that the initial portion is not required to be restricted from prefetching, by identifying that the initial portion appears in multiple video content items. In another embodiment, the one or more processors are configured to identify that the initial portion is not required to be restricted from prefetching, by identifying that the initial portion is an advertisement, a trailer, a list of credits or an audio song. In an embodiment, the one or more processors are configured to receive a notification that specifies the initial portion.

There is also provided, in accordance with an embodiment of the present invention, a method including identifying that multiple different video content items, which are available for consumption over a communication network, contain a common interval having the same content. A single instance of the identified common interval is prefetched to a cache memory of a user device, for display with any of the multiple video content items.

There is further provided, in accordance with an embodiment of the present invention, a method including identifying that a video content item, which is available for consumption over a communication network, is restricted from prefetching due to Digital Rights Management (DRM) protection, but that an initial portion of the video content item is not required to be restricted from prefetching. The initial portion is prefetched to a cache memory of a user device.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a content delivery system, in accordance with an embodiment of the present invention; and

FIG. 2 is a flow chart that schematically illustrates a method for prefetching of video content having Common Video Clips (CVC), in accordance with an embodiment of the present invention.

### DETAILED DESCRIPTION OF EMBODIMENTS

### Overview

Embodiments of the present invention that are described herein provide improved methods and systems for prefetching video content to user terminals. In particular, the disclosed techniques are concerned with identification and efficient prefetching and display of video intervals that appear in different video content items. Such intervals are referred to herein as Common Video Clips (CVCs).

In the present context, the term “CVC” refers to an interval of certain video content that appears in multiple different video content items. One example of a CVC is a short video clip that identifies and gives credit to the content provider, the content producer, or the communication network operator. Another example is an advertisement or sponsorship message. Yet another example of a CVC is an introductory clip that is common to a group of videos, e.g., to different episodes of a television series. Typically, but not necessarily, CVCs tend to appear at or near the beginning of the video content items.

In some embodiments, a prefetching subsystem on the network side identifies that multiple different video content items, which are available for prefetching, contain a CVC, i.e., a common interval having the same content. Instead of prefetching each video content item in its entirety (and therefore prefetching the same content of the CVC multiple times), the prefetching subsystem prefetches only a single instance of the identified CVC to the cache memory of the user device.

The user device uses the single instance of the CVC for displaying any of the multiple video content items. The user terminal typically runs a “prefetch agent”—a software component that handles prefetching of content. In some embodiments, the prefetch agent in the user terminal caches the CVC separately from the video content items. When a certain video content item is to be displayed, the prefetch agent serves the CVC and the rest of the video content item, as needed.

The methods and systems described herein eliminate duplicate transfers of the same video content that appears in different video content items. As such, the disclosed techniques save a considerable amount of network bandwidth, and also storage space at the user device. These savings lead to reduce costs and better utilization of network and user-device resource. Various example techniques for identifying and processing CVCs are described herein.

Other embodiments of the present invention relate to video content items that are subject to Digital Rights Management (DRM) protection that prevents prefetching. Such video content items cannot be prefetched and cached in a user device before they are actually requested and consumed. In practice, however, a CVC embedded in such a video should typically not by itself be subjected to DRM restrictions. In some embodiments the prefetching subsystem identifies that a video content item, which is restricted from prefetching due to DRM protection, begins with a CVC. In such a case, the prefetching subsystem may nevertheless prefetch the CVC to the user device cache. This technique solves the problem of enabling immediate playback of DRM-protected videos, without violating the DRM scheme. The technique is further generalized to prefetching of other kinds of initial portions of DRM-protected videos.

### System Description

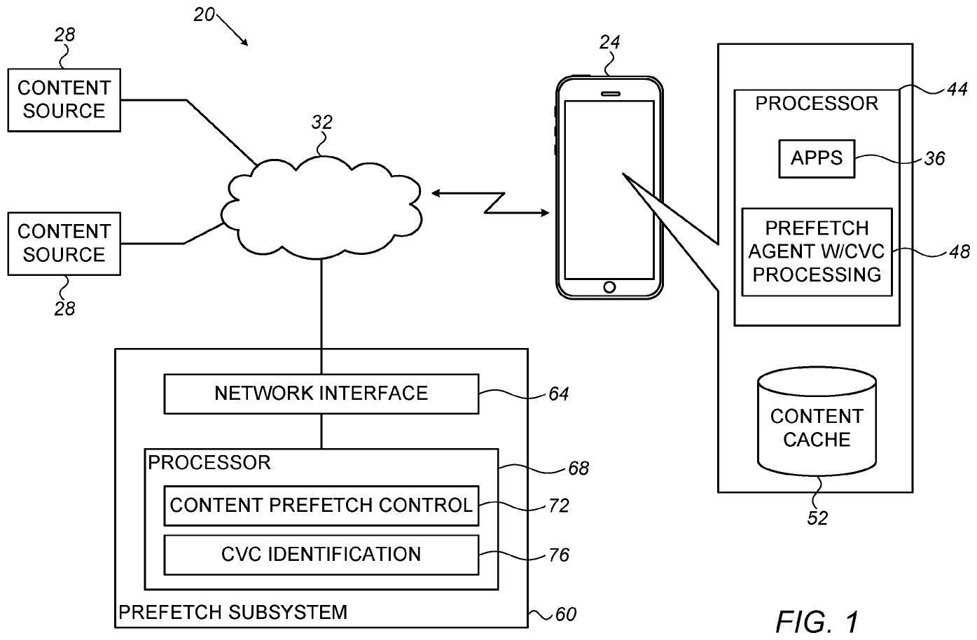

FIG. 1 is a block diagram that schematically illustrates a content delivery system 20, in accordance with an embodiment of the present invention. System 20 comprises a user device 24 that accesses and consumes content items provided by one or more content sources 28 over a network 32. Device 24 may comprise any suitable wireless or wireline device, such as, for example, a cellular phone, car mobile phone or smartphone, a wireless-enabled laptop or tablet computer, a desktop personal computer, a smart television set (TV), a wearable device, or any other suitable type of user device that is capable of communicating over a network and presenting content to a user.

User device 24 may consume content using any suitable software, e.g., using various user applications (“apps”) 36, or using a general-purpose browser. In the present context, a browser is also considered a type of user app. The figure shows a single user device 24 for the sake of clarity. Real-life systems typically comprise a large number of user devices of various kinds.

Network 32 may comprise, for example a Wide Area Network (WAN) such as the Internet, a Local Area Network (LAN), a wireless network such as a cellular network or Wireless LAN (WLAN), or any other suitable network or combination of networks.

Content sources 28 may comprise, for example, Web content servers, or any other suitable sources of content. The disclosed techniques can be used with any suitable types of content items, such as, for example, Web pages, audio or video clips, html files, java scripts and/or CSS files, to name just a few examples. The embodiments described herein are mainly concerned with video content items.

In some embodiments, system 20 performs prefetching of content items to user device 24. In the present example, user device 24 comprises a processor 44 that carries out the various processing tasks of the user device. Among other tasks, processor 44 runs user apps 36, and further runs a software component referred to as a prefetch agent 48 that handles prefetching of content items for apps 36. As part of its functionality, prefetch agent supports caching and processing of Common Video Clips (CVC) using methods that are described below. User device 24 further comprises a content cache 52 for caching prefetched content items. Cache 52 is typically managed by prefetch agent 48.

Typically, prefetch agent 48 receives prefetched content items and stores them in content cache 52. Prefetch agent 48 may intercept user requests to access content items, and determine whether a requested item already resides in the cache. If so, the prefetch agent may retrieve the requested content item from the content cache. Otherwise, the prefetch agent would typically retrieve the requested content item from content sources 28 over network 32. In an embodiment, prefetch agent 48 may also assist in tracking historical usage patterns, and other relevant data related to the user device, which can be used as inputs for specifying prefetch policies for content.

User device 24 typically also comprises a suitable network interface (not shown in the figure) for connecting to network 32. This network interface may be wired (e.g., an Ethernet Network Interface Controller—NIC) or wireless (e.g., a cellular modem or a Wi-Fi modem). Typically, user device 24 further comprises some internal memory (not shown in the figure) that is used for storing relevant information, such as the applicable prefetch policy.

In the embodiment of FIG. 1, system 20 further comprises a prefetching subsystem 60 that performs the various content prefetching related tasks on the network side. Subsystem 60 comprises a network interface 64 for communicating over network 32, and a processor 68 that helps carry out the various processing tasks of the prefetching subsystem. In the present example, processor 68 runs a Content Prefetching Control unit (CPC) 72 that carries out content prefetching, and a CVC Identification unit (CVCI) 76 that identifies Common Video Clips. The CVC identification process is described in detail below.

In an example embodiment, CPC 72 defines a prefetch policy, which specifies how content is to be prefetched to user device 24. For example, CPC 72 may determine which content items are to be prefetched from content sources 28 to content cache 52, e.g., based on the likelihood that the user will request the content items. The CPC may determine the appropriate time for prefetching content items, e.g., based on a prediction of the time the user is expected to request them, and/or availability of communication resources.

The CPC may determine how content items are to be delivered to cache 52, e.g., over a Wi-Fi or cellular connection. As yet another example, the CPC may determine the format with which content items are to be delivered to the user device, e.g., whether and how to perform compression or to deliver only changes for the case that an update has occurred for given content that has already been prefetched (i.e., differential prefetch updates instead of re-prefetching the whole given content from scratch).

In some embodiments, CPC 72 may generate Prefetch Notifications (PNs) that inform user device 24 of available content updates that are relevant for prefetching. For example, if CPC 72 decides that an identified content update is significant for a particular user, the CPC may notify prefetch agent 48 running in the corresponding user device 24 that a change has occurred by sending a PN. The PN can be sent using any suitable notification mechanism, e.g., Google Cloud Messaging (GCM) or Firebase Cloud Messaging (FCM) used for Android devices, or Apple Push Notification (APN) used for iOS devices.

In various embodiments, as part of applying the prefetch policy, CPC 72 may estimate, for each content item, the likelihood that the user of user device 24 will request access to the content item. Such likelihood metrics can be sent to user device 24, and may be used by prefetch agent 48 in ranking prefetch priorities for the different content items. The likelihood estimation in CPC 72 may take into account various factors. Some factors may be user-related (e.g., gender, geographical location, interests, and/or recent and historical Internet activity). Other factors may be environment-related (e.g., time-of-day, road traffic conditions, weather, current events, and/or sporting occasions). Yet other factors may be content-related (e.g., content topic or category, content keywords, identity of the content source, and/or the current popularity or rating of the content).

In some embodiments, CPC 72 estimates the time the user is likely to access a content item in order to help determine the prefetch priorities of the various content items and/or the timing of the prefetch. These time estimates might be separately specified as part of the prefetch policy sent to the device, or they might be incorporated into likelihood metrics themselves. For example, a content item that is likely to be accessed within one hour might be given a higher likelihood metric than a content item that will not be needed for at least two hours.

Additionally or alternatively to the likelihood of the user accessing the content, other factors that CPC 72 may consider in specifying the prefetch policy may comprise power consumption considerations (e.g., preference to prefetch while a Wi-Fi connection or a strong cellular connection is available), transmission cost considerations (e.g., preference to lower-cost data transfer times), network congestion and server load considerations (e.g., preference to prefetch during off-peak traffic hours), and/or other user-related or network-related considerations.

Further additionally or alternatively, in specifying the prefetch policy, CPC 72 may associate certain times-of-day with respective prefetch priority levels. This association may be performed separately for different apps or content sources, or jointly for multiple apps or content sources. One example factor in determining the prefetch priority levels is the estimated likelihood of the user accessing the different apps or content sources during various times-of-day. Assigning a high priority to a prefetch operation typically translates to the prefetch operation being likely to occur (possibly conditioned on certain constraints or limitations).

Certain aspects of content prefetching, and content prefetching schemes that can be used by subsystem 60 and agent 48, are addressed in U.S. Patent Application Publication 2016/0021211, cited above. For example, CPC 72 may choose between various prefetching modes, e.g., a guaranteed prefetching mode and a best-effort prefetching mode. In the guaranteed prefetching mode, CPC 72 continuously tracks changes in content on content sources 28 (e.g., at predefined tracking intervals) and ensures that content cache 52 in user device 24 is regularly updated by prefetching to be synchronized with the content sources (e.g., at predefined guaranteed-mode prefetching intervals). In the best-effort mode, the CPC typically performs prefetching only as feasible using the available resources.

For example, in the best-effort mode, prefetching may be restricted to scenarios in which the user device's modem is active anyhow, scenarios in which a particularly robust network connection exists, or scenarios that involve a non-metered connection (e.g., Wi-Fi but not cellular). The guaranteed prefetching mode may be utilized during one or more time-of-day intervals in which the likelihood of a user accessing a content source has been predicted to be high. Other considerations that can affect the choice between the guaranteed and best-effort modes can be based on various prefetching policy considerations, e.g., power consumption, transmission cost, network congestion and/or server load. The choice of mode can also be made separately for different applications and/or content sources.

In some embodiments, CPC 72 regularly monitors content sources 28 and generates a “prefetch catalog”—a catalog of content items available for prefetching. Each content item is represented in the catalog by an identifier (ID) and a version number indication. The version numbers enable CPC 72 and/or prefetch agent 48 to determine, for example, whether a certain content item has changed relative to the version cached in cache 52 of user device 24. The catalog may also comprise the likelihood metrics described above, links or addresses from which the content items can be retrieved, and/or any other relevant information. The catalog is considered part of the prefetch policy, along with any other prefetch rules, strategies, thresholds or other policy matters defined by CPC 72.

The configurations of system 20 and its various elements shown in FIG. 1 are example configurations, which are chosen purely for the sake of conceptual clarity. In alternative embodiments, any other suitable configurations can be used. For example, the functions of prefetching subsystem 60 and agent 48 can be implemented using any desired number of processors, or even in a single processor. The various functions of subsystem 60 and agent 48 can be partitioned among the processors in any suitable way. In another embodiment, some or all of the functions of subsystem 60 may be performed by agent 48 in user device 24.

As another example, prefetch agent 48 may be implemented in a software module running on processor 44, in an application running on processor 44, in a Software Development Kit (SDK) embedded in an application running on processor 44, by the Operating System (OS) running on processor 44, or in any other suitable manner. In an embodiment, processor 44 may run a proxy server, which is controlled by prefetch agent 48 and is exposed to incoming and outgoing traffic.

Further alternatively, the functionality of prefetch agent 48 can be implemented entirely on the network side without an agent on user device 24. Further alternatively, some of the functionality of prefetch agent 48 can be implemented on the user-device side, and other functionality of prefetch agent 48 can be implemented on the network side. For example, a cloud-based prefetch server may track content items on content source 28, and report changes in content to a prefetch agent in the user device (possibly residing in the user device operating system).

Generally, the functions of the different systems elements described herein (e.g., prefetch agent, content sources and elements of subsystem 60) can be partitioned in any other suitable way. Thus, in the context of the present patent application and in the claims, the disclosed techniques are carried out by one or more processors. The processors may reside in user device 24, and/or on the network side such as in subsystem 60 and/or in content sources 28.

Although the embodiments described herein refer mainly to human users, the term “user” refers to machine users, as well. Machine users may comprise, for example, various host systems that use wireless communication, such as in various Internet-of-Things (IoT) applications.

The different elements of system 20 may be implemented using suitable software, using suitable hardware, e.g., using one or more Application-Specific Integrated Circuits (ASICs) or Field-Programmable Gate Arrays (FPGAs), or using a combination of hardware and software elements. Cache 52 may be implemented using one or more memory or storage devices of any suitable type. In some embodiments, agent 48 and/or subsystem 60 may be implemented using one or more general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Efficient Prefetching of Videos Comprising Common Video Clips

In some embodiments, content sources 28 provide video content items for consumption by user devices 24. For brevity, video content items are referred to herein simply as “videos.” Videos may be consumed in various ways, e.g., by real-time streaming or off-line download and viewing, although the embodiments described herein refer mainly to streaming video. A video is typically divided in time into segments referred to as “Video Segments” (VSs). The partitioning into segments, and the segment format, may differ in accordance with the applicable video standard, e.g., MPEG or HLS. Among other tasks, prefetching subsystem 60 and agent 48 perform efficient prefetching of videos.

In some cases, an identical video interval, having the same content, appears in multiple different videos. Such an interval is referred to herein as a “common interval” or a Common Video Clip (CVC). A CVC may comprise, for example, a video interval that identifies the content provider, the content producer, or the communication network operator. Such CVC (sometimes referred to as a “video logo”) may appear in all the videos produced by the same content provider, in all the videos produced by the same content producer, or in all the videos sent over the network of the same network operator, for example.

Another example of a CVC that appears in multiple different videos is an advertisement or sponsorship message. Certain aspects of handling on-line advertisements are described, for example, in U.S. Patent Application Publication 2016/0063577, whose disclosure is incorporated herein by reference. Yet another example is an introductory clip that is common to a group of videos, e.g., to different episodes of a series, e.g., television series. The types of CVCs listed above are chosen purely by way of example. The disclosed techniques can be used with any of these CVC types, or with any other suitable type of CVC.

It should be noted that the location of a CVC in a video is typically independent of the division of the video into VSs. For example, a CVC may occupy only a portion of a VS, or a CVC may begin in one VS and end in a subsequent VS. This independence often stems from the fact that a video is typically divided into VSs after the CVC is embedded in it, and without any relation or knowledge of the existence of the CVC. Moreover, for a certain CVC, the location of the CVC and its relation to the VSs may vary from one video to another. In some cases, a certain video may comprise multiple CVCs, either in different VSs or even in the same VS.

In some embodiments, CVC Identification unit (CVCI) 76 in prefetch subsystem 60 identifies CVCs in videos provided by content sources 28. Upon identifying a CVC, CVCI 76 notifies CPC 72 that a certain VS of a certain video comprises a CVC. CPC 72 indicates the existence of the CVC in the prefetch catalog that is sent to user device 24 as part of the prefetch policy.

In one example embodiment, CVCI 76 holds a predefined list of CVCs, e.g., per content source. An instance of each CVC may be stored in a suitable memory of prefetch subsystem 60. The list may specify, per CVC, the location of the CVC (e.g., start and end position, or start position and size) in any video the CVC appears in. For HLS videos, in which each video is represented by multiple files and a map (index) file, the location of the CVC may be specified in terms of the file in which it is located.

Additionally or alternatively, the information regarding CVCs (e.g., the above-described list or parts thereof) may be included in the prefetch catalog that is provided by CPC 72 to user device 24 as part of the prefetch policy. In one embodiment the prefetch policy may comprise a separate entry for the CVC, and/or a reference for each video containing the CVC, indicating the CVC location in the video. In some embodiments, the information needed for specifying a CVC for a certain content source 28 may be provided by a content provider or Content Delivery Network (CDN).

In some embodiments, CVCI 76 is capable of searching for CVCs on a certain content source 28, without being given a-priori information on CVCs. In various embodiments, CVCI 76 may search for CVCs on a content source in various ways. In some embodiments, CVCI 76 may examine the first VS of each video, and compare the first VSs in an attempt to find matching portions of identical video content.

In one embodiment, CVCI 76 compares the initial bits of the first VSs to one another, assuming that if a CVC exists, it will be found at or near the beginning of the first VS. In another embodiment, CVCI 76 evaluates various hypothesized starting points for the CVC in a given first VS. This sort of search may assume that the starting point is the same for all videos, or it may assume that the starting point of the CVC may vary from one video to another. As noted above, the search is not limited to the first VSs of the videos.

In some embodiments, when comparing portions of different videos in an attempt to find a CVC, CVCI 76 considers only exact bit-wise matches between videos as a possible CVC. In other embodiments the CVC may also consider approximate matches, i.e., bit sequences that are not identical but are sufficiently similar in accordance with some predefined metric.

In some video formats, a video content item comprises both a video bit-stream and an audio bit-stream. In the present context, searching and comparing portions of video refers to searching and comparing the video bit-streams and/or the audio bit-streams.

In some embodiments, CVCI 76 declares a common interval as a CVC only if the interval meets some predefined criterion that justifies the processing involved. For example, CVCI 76 may decide to process a certain common interval as a CVC only if the interval appears in more than a predefined number of videos. As another example, CVCI 76 may decide to process a certain common interval as a CVC only if the interval is longer than a predefined length. The rationale behind these criteria is that the overhead of CVC processing may not be justified if the interval is too short or if it appears in a small number of videos. Additionally or alternatively, CVCI may use any other suitable criteria.

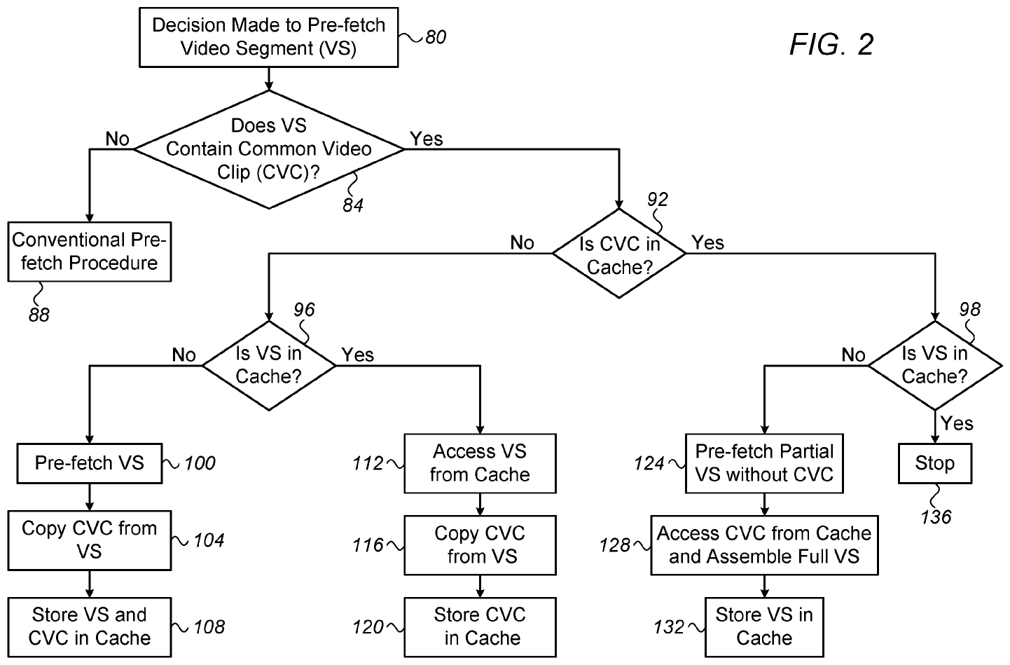

FIG. 2 is a flow chart that schematically illustrates a method for prefetching of a video comprising a CVC, in accordance with an embodiment of the present invention. The method is carried out by, and described from the perspective of, prefetch agent 48 in user device 24. In the present example, agent 48 has previously received from CPC 72 a prefetch policy that indicates that the video in question comprises a CVC, and specifies the location of the CVC in the video.

The method begins with prefetch agent 48 deciding to prefetch a certain VS of the video, at a prefetch decision step 80. At a CVC checking step 84, agent 48 checks whether the VS to be prefetched contains the CVC. If not, agent 48 prefetches the VS conventionally to cache 52, at a conventional prefetching step 88.

If, according to the prefetch policy, the VS to be prefetched contains the CVC, agent 48 checks whether the CVC in question is already cached in cache 52, at a CVC cache checking step 92. Depending on the result, agent 48 checks whether the VS itself is already cached in cache 52, at VS caching steps 96 and 98. By performing steps 92, 96 and 98, agent 48 distinguishes between four different cases that are handled differently. The four cases are illustrated from left to right in the figure:
Both VS and CVC are not cached: In this case, agent 48 prefetches the entire VS, including the CVC, at a VS prefetching step 100. Agent 48 then copies the CVC from the VS, at a CVC extraction step 104. Agent 48 stores the VS and the CVC in cache 52, separately from one another, at a VS & CVC caching step 108. From this point, the CVC is available in cache 52 and can be served from the cache and displayed with any video that is known to contain it. Such a video may be itself prefetched or fetched in real-time over the network.
VS is cached, CVC is not cached separately: This case may occur, for example, when the VS was prefetched before the CVC was identified. In this case, agent 48 accesses the cached VS in cache 52, at a VS accessing step 112. Agent 48 copies the CVC from the VS, at a CVC extraction step 116, and stores the extracted CVC in cache 52, at a CVC caching step 120. Here, too, the CVC is now available in cache 52 and can be served from the cache and displayed with any video that is known to contain it.
CVC is cached, but VS is not cached: In this case, agent 48 prefetches the “partial VS,” i.e., the VS excluding the CVC, at a partial prefetching step 124. Agent 48 then accesses the cached CVC in cache 52, and assembles the full VS from (i) the prefetched partial VS and (ii) the cached CVC, at an assembly step 128. At a VS caching step 132.
Both VS and CVC are cached: In this case, no further action is required, and the method terminates at a termination step 136.

The method flow of FIG. 2 is an example flow that is depicted purely for the sake of clarity. In alternative embodiments, agent 48 may prefetch VSs containing CVCs using any other suitable flow.

For example, in the embodiment described above, agent 48 stores the full VS (including the CVC) in cache 52, and in addition stores the CVC in cache 52 separately. This configuration simplifies the serving of VSs but requires more memory space. In an alternative embodiment, agent 48 may store only the partial VS (without the CVC) in cache 52, and in addition store the CVC in cache 52 separately. The latter embodiment is more efficient in using cache 52. In this embodiment, when the VS is to be displayed, the requesting application 36 (e.g., media player) may first access the partial VS and the CVC in cache 52, and assemble the full VS.

As another example, the method of FIG. 2 refers to prefetching of a VS (which is known to comprise a CVC) before it is requested by application 36 (e.g., media player). In an alternative embodiment, a similar method can be used for fetching the VS in real-time. In such an embodiment, if the CVC (but not the rest of the VS) has been previously prefetched (e.g., for another VS) and is stored in cache 52, processor 44 of user device 24 may fetch only the partial VS (without the CVC) in real-time. Processor 44 may then combine, in real-time, the partial VS with the cached CVC to produce the full VS. This technique reduces data transfer download requirements, which in turn reduces network congestion, download time, and power consumption of user device 24.

As yet another example, the method of FIG. 2 assumes that agent 48 prefetches a CVC when it prefetches a VS containing the CVC. In alternative embodiments, once a CVC is identified, CPC 72 or agent 48 may decide to prefetch the CVC separately, regardless of whether any VS containing the CVC is prefetched or fetched in real-time. This scenario may occur, for example, if the prefetch priority assigned to the CVC is higher than that of the VS.

As still another example, the method of FIG. 2 may assume that agent 48 prefetches a CVC from the same location it prefetches the VS containing the CVC. This location may be a storage location associated, for example, with content source 28 or prefetch subsystem 60. In alternative embodiments, CVCs may be stored separately in prefetch subsystem 60 and may be prefetched independently of the location of any particular VS. The location (e.g., address) from which a CVC should be prefetched can be indicated, for example, in the prefetch policy sent from CPC 72 to agent 48.

In some embodiments, the prefetch policy provides Cyclic Redundancy Check (CRC) values, which are calculated over full VS that comprises a CVC. When prefetching a partial VS and reassembling the VS by combining the partial VS with a CVC cached in cache 52 (as in steps 124-132 of FIG. 2), agent 48 may verify the reassembly process by comparing the CRC value provided in the prefetch policy with a CRC value calculated over the reassembled VS. In some embodiments, the prefetch policy may provide a CRC value for the full VS, and also CRC values calculated separately over the CVC and/or the partial VS (excluding the CVC).

### CVC Position Considerations

The description above referred mainly to cases in which the CVC is located at or near the beginning of the video. This case is of interest, because in some embodiments system 20 limits prefetching of video to the first VS of the video anyhow in order to reduce the cost of prefetching. Prefetching the first VS also provides significant performance gain, because subsequent VSs may be fetched later while previous VSs are being played. Thus, in some embodiments CVCI 76 may limit the search for CVCs to the first VS of each video.

In another example embodiment, CVCI 76 limits the search for CVCs to the first and last VSs of each video. This technique is useful, for example, because some content providers tends to position CVCs at the end of their videos, and since some video formats require the media player to initially access data at the end of the video.

Alternatively, CVCI 76 may limit the search for CVCs to any other suitable subset of the segment positions of each video. Further alternatively, CVCI 76 48 may search for CVCs in any other segment or segments of the video, even in all segments. System 20 may use the disclosed techniques to process CVCs found anywhere in the videos.

### Encoding Rate Considerations

In some video formats, content source 28 provides multiple copies of a video, each copy encoded at a different encoding rate (corresponding to a different compression ratio). Higher encoding rates correspond to higher media quality but higher bandwidth, and vice versa. Such video formats allow applications 36 (e.g., media players) to select the encoding rate that best matches the current conditions, e.g., wireless channel conditions or available bandwidth.

In some embodiments, CVCI 76 identifies CVCs by comparing VSs having the same encoding rate. When a CVC is identified in the VSs of one encoding rate, the CVCI may deduce that the same CVC will be found at the same location in the corresponding VSs of the other encoding rates. This feature eliminates the need for duplicating the search over VSs of different encoding rates of the same video.

In some embodiments, system 20 prefetches multiple copies of a CVC at multiple different encoding rates, and stores the multiple copies in cache 52 of user device 24. In some cases, however, it may be sufficient to prefetch and cache CVCs only in a predefined partial subset of the encoding rates, e.g., at a single selected encoding rate.

For example, in some video formats it can be assumed that the initial part of the video (e.g., the first VS) will always be accessed at a predefined default encoding rate (e.g., the lowest encoding rate). Thus, in some embodiments, CVCs identified in the initial parts of the videos (e.g., in the first VS) may be prefetched by system 20 only at the default encoding rate.

In another example embodiment, system 20 may prefetch a CVC at a high encoding rate to cache 52. The requesting application 36 (e.g., media player) can then access the cached CVC and convert it to any other desirable encoding rate (e.g., a lower rate) in real-time when accessing a VS that contains the CVC. Alternatively, prefetch agent 48 may access the cached CVC and convert it to the appropriate encoding rate that matches the rate of an associated partial VS being prefetched, so that the full VS can be cached in cache 52 at this encoding rate.

In other embodiments, system 20 may prefetch the CVC at a high encoding rate. Agent 48 may then convert the prefetched CVC into multiple copies having different encoding rates, and cache the multiple copies in cache 52. In this manner, the multiple copies of the CVC are available immediately in cache 52 at any desired rate.

In yet another embodiment, an application 36 (e.g., media player) accesses and plays a cached CVC at an encoding rate that is different from the encoding rate of the rest of the VS being played. For this purpose, the media player or prefetch agent may construct a “hybrid VS,” in which the CVC is encoded using one encoding rate, and the remainder of the VS is encoded using a different encoding rate.

### CVC Selection and Prioritization

In some embodiments, system 20 (e.g., CPC 72 and/or agent 48) may decide to prefetch only part of a CVC. For example, if the CVC is long, it is possible to prefetch only the first portion of the CVC that corresponds in size to the buffer size of the requesting application (e.g., media player). In other words, system 20 may prefetch and cache in cache 52 only the part of the CVC that the media player needs in order to fill its buffer and begin playback.

In some embodiments, CPC 72 assigns priorities to CVCs. CVCs having high priorities are given precedence in prefetching over CVCs having lower priorities. Additionally or alternatively, CPC 72 may decide which of the identified CVCs to prefetch, and/or how much of a given CVC is to be prefetched. These decisions may be based on factors such as storage-space, power consumption and/or data-plan limitations in user device 24. A non-limiting list of example factors comprises the following:
The number of videos the CVC appears in. For example, CPC 72 may decide to prefetch only the N (e.g., five) most common CVCs that appear in a certain percentage (e.g., 75%) of the videos in a content source.
The location of the CVC in the video. For example, CPC 72 may assign a high prefetch priority for a CVC located at the beginning of the video, since caching this CVC in user device 24 ahead of time enables the video to be played without prefetching additional portions of the video, thereby eliminating latency. On the other hand, if the CVC appears at the end of the video, prefetching and/or caching a single instance of the CVC for use by many videos potentially saves data transfer and/or device storage, but typically does not significantly reduce latency.
Likelihood metrics associated with the videos containing the CVCs. CPC 72 may assign higher priority to prefetching CVCs that are found in videos that re more likely to be consumed by the user, and vice versa. The likelihood metrics are typically based on the user's content consumption preferences. For example, CPC 72 may decide to prefetch a CVC that appears in 1% of the videos instead of a CVC that appears in 5% of the videos, if the likelihood metrics indicate that the user is more likely to access the former videos is higher.
Storage space available at the user device. When more storage space is available in user device 24, more storage space may be allocated for prefetching CVCs, and vice versa. In some embodiments, the amount of available storage space for prefetching may itself be defined at the user device. CPC 72 may consider the available storage space when choosing which CVCs to prefetch. For example, CPC 72 may choose the N most common CVCs that fit into 10% of the available prefetch storage space in the user device.
Digital Rights Management (DRM) limitations. In some cases, prefetching a CVC may solve a DRM limitation. For example, certain videos cannot be prefetched and cached in the user device ahead of time because of DRM restrictions. Prefetching and caching a CVC located at the beginning of these videos can often solve this problem. The media player may be able to obtain sufficient buffered data based on the prefetched CVC to begin playback immediately, without violating the DRM restrictions. DRM considerations are addressed in further detail below.
CVC size. As noted above, CPC 72 may decide, for example, to avoid prefetching a very small CVC if the potential performance gain is small (e.g., small data transfer savings, small storage savings, or CVC size is too small to fill the media player buffer to eliminate latency and/or to eliminate DRM issues).

Additionally or alternatively, CPC 72 may prioritize CVCs, decide which CVCs to prefetch, and/or decide how much of a CVC to prefetch, based on any other suitable criterion.

### Digital Rights Management (DRM) Considerations

Some videos are subject to DRM restrictions. In particular, some DRM schemes prevent videos from being prefetched and cached in a user device before they are actually requested and consumed. In one example, a video may be protected by a DRM scheme that restricts its consumption to a specified time window. This sort of DRM scheme is referred to herein as a “Prefetch-Restricting DRM” (PRDRM) scheme. One example of PRDRM is a scheme in which the video is encoded with a code having a key that is valid only during the specified time window.

Unless the time window is sufficiently large, this type of scheme prevents prefetch operation since the content accessibility will often expire before it is accessed by the user and retrieved from cache. In this case the PRDRM scheme might not technically prevent transferring the prefetched content to the device ahead of time, but it prevents the prefetched content from being accessed by the user, i.e., it prevents the prefetch operation from being useful. In the present context, preventing the prefetch operation from being useful, even though the content has been prefetched to the user device, is also regarded as content that is “restricted from prefetching.”

Other PRDRM schemes, i.e., DRM schemes that restrict prefetching, may comprise, for example, schemes that disable direct download of content or prevent saving content to memory. In such PRDRM schemes, the content may be accessible for download and saving, for example, only by a particular media player (e.g., a media player possessing a certain key) that can trigger the direct streaming of the content only to it and its buffers. Alternatively, the disclosed techniques can be used with any other suitable PRDRM scheme.

In practice, however, a CVC embedded in a PRDRM-protected video should typically not by itself be prevented from prefetching. Thus, in some embodiments, when CVCI 76 identifies a CVC at the beginning of a video subject to PRDRM protection, CPC 72 may still decide to prefetch the CVC to user device 52. As explained above, this technique solves the problem of enabling immediate playback of PRDRM-protected videos, without violating the PRDRM scheme.

Note that references herein to content that should not be prevented from prefetching is meant to indicate that the content provider does not require the content to be prevented from prefetch (even though the content may be encoded or formatted in a way that prevents prefetching).

In some embodiments, the PRDRM scheme regards the video as restricted from prefetching, but does not impose a technical obstacle that prevents prefetching. In such a case (assuming the content provider is willing to allow prefetching of the CVC) CPC 72 may prefetch the CVC without additional processing.

In other embodiments, certain additional processing should be performed in order to implement the above technique. For example, when the PRDRM scheme encodes the video in a format that prevents its prefetching, the CVC at the beginning of the video may need to be converted into a non-PRDRM format. This conversion may be performed by the content provider, i.e., the content provider may provide a version of the CVC in a format that enables prefetching. The CPC may receive this version of the CVC without requesting it, i.e., on the initiative of the content provider, or the CPC may initiate the download of this version. Alternatively, the conversion may be performed by the CPC. In the latter case, the content provider may assist CPC 72 in performing the conversion by providing information that enables the conversion (e.g., a suitable key).

As another example, consider a case in which the media player that plays PRDRM-protected videos in user device 24 is unable to play non-PRDRM video. In such a case, user device 24 may invoke a second media player in parallel, in order to play the non-PRDRM CVC portion of the video. When the non-PRDRM media player completes playback of the CVC portion, user device 24 switches over to the first media player for playing the subsequent (PRDRM-protected) video content. The switchover is typically synchronized between the two players, and is thus transparent to the user.

As yet another example, an existing portion of a streaming video (e.g., a HLS file) may contain both a CVC and other (non-CVC) content. In an embodiment, when converting the CVC to non-PRDRM format, CPC 72 may reorganize some of the streaming files so that each individual file contains only non-PRDRM content, or only PRDRM content. This reorganization may simplify the handling of the PRDRM/non-PRDRM mixture of content in user device 24, since the switch-over would occur at file boundaries.

For example, consider a video which has a default HLS file size of ten seconds, and a CVC that is thirty-two seconds long. In order to simplify the implementation of the above technique, CPC 72 may convert the first four HLS files (of ten seconds each) into five HLS files (of eight seconds each). Four of these files will contain a non-PRDRM CVC, and one file will contain the subsequent first eight seconds of PRDRM-protected video.

In some embodiments, system 20 may use the above techniques for prefetching other kinds of initial portions of videos that may not or should not be restricted from prefetching by PRDRM protection. In other words, any of the processors in system 20 may identify that a video, which is available for consumption over network 32, is restricted from prefetching due to DRM protection, but that an initial portion of this video is not restricted from prefetching, or at least should not be restricted from prefetching. In response, the processor may prefetch the initial portion to cache 52 of user device 24, notwithstanding the PRDRM restrictions imposed on the rest of the video. In such cases, too, the problem of enabling immediate playback of PRDRM-protected videos is resolved without violating the PRDRM scheme.

One example of identifying an initial portion that should not be restricted from prefetching, is identifying a common interval that appears in multiple videos. Generally, however, the initial portion need not necessarily appear in multiple videos. Generally speaking, any initial portion of video that is regarded by the provider as not required to be prevented from prefetching can be processed using the disclosed techniques. Non-limiting examples of initial portions of video that typically should not be prevented from prefetch may comprise, for example:
An advertisement.
A movie trailer appearing in the beginning of a video.
A list of credits to actors, writers, producers, etc., that appears in the beginning of a video.
An audio song played at the beginning of a video.
An initial video portion that does not differ in characteristics from the rest of the video, but for which the provider is willing to waive the PRDRM restriction (in order to gain the enhanced user experience provided by prefetching).

In some embodiments, CPC 72 may receive a notification that specifies the initial non-PRDRM portion from the content provider or other external system. In some embodiments, the content provider may post the initial non-PRDRM portion of the video on content source 28 in a non-PRDRM format in the first place.

In some embodiments, in any of the above examples, the initial portion of the video may need to be converted to a non-PRDRM format before it can be prefetched. As explained above, the conversion may be performed by the content provider, or by CPC 72 (possibly with the assistance of information received from the content provider). In other embodiments the initial portion may be prefetched as-is, without conversion.

In some embodiments, the initial portion might be transferred to user device 24 in the PRDRM format, and then converted to non-PRDRM format by agent 48 in the user device. This conversion may be performed either before caching the initial portion in cache 52, or after retrieving the initial portion from cache 52 when the user accesses it.

In other embodiments, the initial portion is prefetched and stored in cache 52 of user device 24 in PRDRM format. Then, when the user accesses it (possibly outside the valid time window), agent 48 or the requesting application (e.g., media player) applies an override to unlock the access restriction so that the user can view the content (e.g., based on a key provided by the content provider for this initial portion).

In any of the above examples, the video in question may also be subject to a DRM scheme that does not restrict prefetching, e.g., a DRM scheme that restricts consumption of the video to a specified user device. This sort of DRM scheme has no effect on the disclosed techniques.

Although the embodiments described herein mainly address video content items, the methods and systems described herein can also be used in other applications, such as in processing of audio (e.g., music) files.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An apparatus, comprising:
a network interface for communicating over a communication network; and
one or more processors, configured to:
identify that multiple different video content items, which are available for consumption over the communication network, contain a common interval having the same content;
prefetch a single instance of the identified common interval to a cache memory of a user device, for display with any of the multiple video content items; and
cache or display the single instance of the common interval in the user device, in a different encoding rate than an encoding rate used for displaying at least one of the video content items.

2. The apparatus according to claim 1, wherein the one or more processors are configured to display the prefetched single instance of the common interval with a video content item that is prefetched, or with a video content item that is fetched and displayed in real-time.

3. The apparatus according to claim 1, wherein the one or more processors are configured to receive a notification that specifies the common interval, from a system external to the apparatus.

4. The apparatus according to claim 3, wherein the notification specifies respective locations of the common interval in two or more of the video content items.

5. The apparatus according to claim 1, wherein the one or more processors are configured to identify the common interval by comparing portions of two or more of the video content items.

6. The apparatus according to claim 1, wherein the one or more processors are configured to prefetch the single instance of the common interval, only if the common interval appears in more than a predefined number of video content items.

7. The apparatus according to claim 1, wherein the one or more processors are configured to prefetch the single instance of the common interval, only if the common interval is longer than a predefined length.

8. The apparatus according to claim 1, wherein the one or more processors are configured to store the single instance of the common interval in the cache memory of the user device separately from any of the multiple video content items.

9. The apparatus according to claim 1, wherein the one or more processors are configured to prefetch the single instance of the common interval as part of prefetching or fetching a segment of one of the multiple video content items.

10. The apparatus according to claim 1, wherein the one or more processors are configured to prefetch the single instance of the common interval independently of prefetching or fetching any segment of the multiple video content items.

11. The apparatus according to claim 1, wherein the one or more processors are configured to determine that the single instance of the common interval is already cached in the cache memory of the user device, and in response to fetch or prefetch only a partial segment of one of the multiple video content items that excludes the common interval.

12. The apparatus according to claim 1, wherein the one or more processors are configured to display a segment of one of the multiple video content items that comprises the common interval, by (i) fetching or prefetching a partial segment that excludes the common interval and (ii) assembling the segment by combining the partial segment with the cached single instance of the common interval.

13. The apparatus according to claim 1, wherein the one or more processors are configured to search for the common interval only within a predefined partial subset of segments positions in the video content items.

14. The apparatus according to claim 1, wherein multiple copies of the video content items are available at multiple respective encoding rates, and wherein the one or more processors are configured to identify the common interval and prefetch the single instance in only a predefined partial subset of the multiple encoding rates.

15. The apparatus according to claim 1, wherein the one or more processors are configured to prefetch only a portion of the single instance of the common interval, which is sufficient for starting immediate playback in the user device.

16. The apparatus according to claim 1, wherein the one or more processors are configured to prefetch the single instance even though the video content items are subject to Digital Rights Management (DRM) protection.

17. The apparatus according to claim 16, wherein the one or more processors are configured to convert the single instance into a non-DRM format.

18. An apparatus, comprising:
a network interface for communicating over a communication network; and
one or more processors, configured to:
identify that a video content item, which is available for consumption over the communication network, is restricted from prefetching due to Digital Rights Management (DRM) protection, but that an initial portion of the video content item is not required to be restricted from prefetching; and
prefetch the initial portion to a cache memory of a user device.

19. The apparatus according to claim 18, wherein the one or more processors are configured to convert the initial portion into a format that enables prefetching of the initial portion, and to prefetch the converted initial portion to the cache memory of the user device.

20. The apparatus according to claim 19, wherein the one or more processors are configured to receive, from a content provider, information that enables conversion into the format that enables the prefetching, and to convert the initial portion using the information.

21. The apparatus according to claim 18, wherein the one or more processors are configured to receive a version of the initial portion in a format that enables prefetching of the initial portion, and to prefetch the received version of the initial portion to the cache memory of the user device.

22. The apparatus according to claim 18, wherein the one or more processors are configured to store the initial portion in the cache memory of the user device in a format that restricts prefetching in accordance with the DRM protection, and, upon retrieving the initial portion from the cache memory in order to present the initial portion, to convert the initial portion into a format that does not restrict the prefetching, or to unlock an access restriction of the initial portion.

23. The apparatus according to claim 18, wherein the one or more processors are configured to identify that the initial portion is not required to be restricted from prefetching, by identifying that the initial portion appears in multiple video content items.

24. The apparatus according to claim 18, wherein the one or more processors are configured to identify that the initial portion is not required to be restricted from prefetching, by identifying that the initial portion is an advertisement, a trailer, a list of credits or an audio song.

25. The apparatus according to claim 18, wherein the one or more processors are configured to receive a notification that specifies the initial portion.

26. A method, comprising:
identifying that multiple different video content items, which are available for consumption over a communication network, contain a common interval having the same content;
prefetching a single instance of the identified common interval to a cache memory of a user device, for display with any of the multiple video content items; and
caching or displaying the single instance of the common interval in the user device, in a different encoding rate than an encoding rate used for displaying at least one of the video content items.

27. The method according to claim 26, and comprising displaying the prefetched single instance of the common interval with a video content item that is prefetched, or with a video content item that is fetched and displayed in real-time.

28. The method according to claim 26, wherein identifying the common interval comprises receiving a notification that specifies the common interval, from a system external to the apparatus.

29. The method according to claim 28, wherein the notification specifies respective locations of the common interval in two or more of the video content items.

30. The method according to claim 26, wherein identifying the common interval comprises comparing portions of two or more of the video content items.

31. The method according to claim 26, wherein prefetching the single instance of the common interval comprises deciding to prefetch the common interval only if the common interval appears in more than a predefined number of video content items.

32. The method according to claim 26, wherein prefetching the single instance of the common interval comprises deciding to prefetch the common interval only if the common interval is longer than a predefined length.

33. The method according to claim 26, wherein prefetching the single instance of the common interval comprises storing the single instance of the common interval in the cache memory of the user device separately from any of the multiple video content items.

34. The method according to claim 26, wherein prefetching the single instance of the common interval is performed as part of prefetching or fetching a segment of one of the multiple video content items.

35. The method according to claim 26, wherein prefetching the single instance of the common interval is performed independently of prefetching or fetching any segment of the multiple video content items.

36. The method according to claim 26, and comprising determining that the single instance of the common interval is already cached in the cache memory of the user device, and in response fetching or prefetching only a partial segment of one of the multiple video content items that excludes the common interval.

37. The method according to claim 26, and comprising displaying a segment of one of the multiple video content items that comprises the common interval, by (i) fetching or prefetching a partial segment that excludes the common interval and (ii) assembling the segment by combining the partial segment with the cached single instance of the common interval.

38. The method according to claim 26, wherein identifying the common interval comprises searching for the common interval only within a predefined partial subset of segments positions in the video content items.

39. The method according to claim 26, wherein multiple copies of the video content items are available at multiple respective encoding rates, and wherein identifying the common interval and prefetching the single instance are performed in only a predefined partial subset of the multiple encoding rates.

40. The method according to claim 26, wherein prefetching the single instance of the common interval comprises prefetching only a portion of the single instance of the common interval, which is sufficient for starting immediate playback in the user device.

41. The method according to claim 26, wherein prefetching the single instance is performed even though the video content items are subject to Digital Rights Management (DRM) protection.

42. The method according to claim 41, and comprising converting the single instance into a non-DRM format.

43. A method, comprising:
identifying that a video content item, which is available for consumption over a communication network, is restricted from prefetching due to Digital Rights Management (DRM) protection, but that an initial portion of the video content item is not required to be restricted from prefetching; and
prefetching the initial portion to a cache memory of a user device.

44. The method according to claim 43, and comprising converting the initial portion into a format that enables prefetching of the initial portion, and prefetching the converted initial portion to the cache memory of the user device.

45. The method according to claim 44, wherein converting the initial portion comprises receiving, from a content provider, information that enables conversion into the format that enables the prefetching, and converting the initial portion using the information.

46. The method according to claim 43, wherein prefetching the initial portion comprises receiving a version of the initial portion in a format that enables prefetching of the initial portion, and prefetching the received version of the initial portion to the cache memory of the user device.

47. The method according to claim 43, and comprising storing the initial portion in the cache memory of the user device in a format that restricts prefetching in accordance with the DRM protection, and, upon retrieving the initial portion from the cache memory in order to present the initial portion, converting the initial portion into a format that does not restrict the prefetching, or unlocking an access restriction of the initial portion.

48. The method according to claim 43, wherein identifying that the initial portion is not required to be restricted from prefetching comprises identifying that the initial portion appears in multiple video content items.

49. The method according to claim 43, wherein identifying that the initial portion is not required to be restricted from prefetching comprises identifying that the initial portion is an advertisement, a trailer, a list of credits or an audio song.

50. The method according to claim 43, wherein identifying the initial portion comprises receiving a notification that specifies the initial portion.

51. The apparatus according to claim 18, wherein the one or more processors are configured to display the video content item in the user device, by:
displaying the video content item, except for the initial portion, using a first media player that is configured for displaying DRM-protected content; and
displaying the initial portion by invoking a second media player that is configured for displaying non-DRM-protected content.

52. The method according to claim 43, and comprising displaying the video content item in the user device, by:
displaying the video content item, except for the initial portion, using a first media player that is configured for displaying DRM-protected content; and
displaying the initial portion by invoking a second media player that is configured for displaying non-DRM-protected content.
